(19) United States
(12) Patent Application Publication
(10) Pub. No.: US 2014/0108937 A1
(43) Pub. Date: Apr. 17, 2014

(54) Model-Based Configuration Capture and Replay in a Converged Infrastructure System to Support Remote Troubleshooting

(71) Applicant: Cisco Technology, Inc., San Jose, CA (US)

(72) Inventors: Raju Datla, Pleasanton, CA (US); Raju S V L N Penmetsa, San Jose, CA (US); Parthasarathy Venkatavaradhan, Sunnyvale, CA (US); Muralidhara SrinivasaRao Alapati, Fremont, CA (US)

(73) Assignee: Cisco Technology, Inc., San Jose, CA (US)

(21) Appl. No.: 14/035,356

(22) Filed: Sep. 24, 2013

Related U.S. Application Data
(60) Provisional application No. 61/712,459, filed on Oct. 11, 2012.

(51) Int. Cl. H04L 12/24

(52) U.S. Cl. CPC H04L 41/0893
USPC 715/735

(57) ABSTRACT

Configuration models are accessed, each configuration model defining configuration attributes to be collected from a respective one of compute, storage, and network components of a converged infrastructure and collecting actual configuration attributes from each of the compute, storage, and network components of the converged infrastructure in accordance with the configuration models. A policy is accessed that defines configuration attribute rules corresponding to each of the configuration attributes collected from the compute, storage, and network components and comparing the collected configuration attributes to the configuration attribute rules for each of the compute, storage, and network components. Results of the comparing are reported, including which of the collected configuration attributes violate the corresponding configuration rules.

### CROSS-REFERENCE TO RELATED APPLICATION

This application claims the benefit of U.S. Provisional Application No. 61/712,459, filed Oct. 11, 2012, which is hereby incorporated by reference in its entirety.

### TECHNICAL FIELD

The present disclosure relates to converged infrastructures.

### BACKGROUND

A data center, cloud resource, or the like, may be implemented in the form of a converged infrastructure (CI). The CI is a set of integrated Information Technology (IT) multi-functional components or devices, such as storage, network, compute, and virtualization components located at a given site. As a result of this integrated arrangement of components, the CI can prove complex in terms of initially configuring the CI for operation and then troubleshooting technical problems that may arise with the operational CI thereafter. Because the CI includes components that span multiple technology domains, e.g., storage, networking, virtualization, and computing domains, each domain requires its own subject matter expert (SME) to troubleshoot technical problems that may arise in a given domain. If an onsite SME cannot diagnose a technical problem with a given component, technical support for the vendor of the component may be called-in to troubleshoot the problem onsite. This can be expensive and time consuming, especially if travel to the onsite location of the CI is involved.

### BRIEF DESCRIPTION OF THE DRAWINGS

FIG. 1 is a block diagram of an example converged infrastructure environment in which a converged infrastructure (CI) is configured by and operates under control of a CI controller.

FIG. 2 is a block diagram of an example CI controller configured to perform operations to implement techniques provided herein as related to the CI from FIG. 1.

FIG. 3 is a flowchart of an example generalized method of model-based capturing and replaying of component configurations in support of both onsite and offsite CI troubleshooting.

FIG. 4 is a block diagram of an example offsite troubleshooting environment.

FIG. 5 is a flowchart of operations for an example method associated with the offsite troubleshooting.

FIG. 6 is an illustration of example configuration models.

FIG. 7 is an illustration of an example policy with configuration attribute rules corresponding to the configuration models in FIG. 6.

FIG. 8 is an example “data-dump” of actual configuration attributes collected from the CI of FIG. 1.

FIG. 9 is an illustration of an example Compare Results Report generated and displayed in a compare operation of the method of FIG. 3.

FIGS. 10 and 11 are illustrations of example replay display menus and generated in replay operations of the method of FIG. 3

### DESCRIPTION OF EXAMPLE EMBODIMENTS

### Overview

Techniques are provided to perform model-based converged architecture (CI) component configuration capturing and replaying is provided herein. These techniques assist with troubleshooting technical problems with the CI in onsite and offsite locations. Initially, configuration models are accessed, where each configuration model defines configuration attributes to be collected from a respective one of compute, storage, and network components of a converged infrastructure. Actual configuration attributes are collected from each of the compute, storage, and network components of the converged infrastructure in accordance with the configuration models. A configuration policy is accessed. The policy defines configuration attribute rules corresponding to each of the configuration attributes collected from the compute, storage, and network components. The collected actual configuration attributes are compared to the configuration attribute rules in the accessed policy for each of the compute, storage, and network components. Results of the compare operation are reported, including which of the collected configuration attributes violate the corresponding configuration rules, if any.

### Example Embodiments

A converged infrastructure (CI) is a modular, integrated, often pre-configured, set of information technology (IT) components, typically including storage, network, compute, and virtualization components, that may be shared across multiple user applications that require storage, network, and compute resources. Due to the modular nature of the CI, the CI components made available to the user applications may be scaled up and down relatively easily and efficiently in order to accommodate corresponding increases and decreases in user application resource requirements. Examples of known converged infrastructures (CIs) include, but are not limited to, FlexPod™ by NetApp and Cisco, VSPEX by EMC, and Vblock™ by VCE. Such known CIs are configured and operated in accordance with respective vendor CI specifications referred to herein as “blueprints” that have become quasi-industry standards.

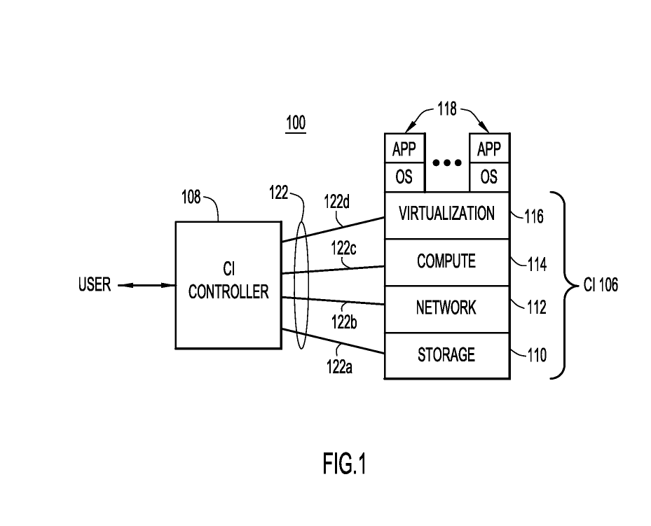

Referring first to FIG. 1, a block diagram of an example (CI) environment 100 is shown in which a CI 106 is configured by and operates under control of, a CI Controller 108. CI 106 includes an integrated set of components, including a storage component 110 to provide data storage, a network component 112 to provide connectivity to external devices and communication networks, a compute or server component 114 to provide processing capacity to the CI, and a virtualization component 116, such as a hypervisor, to host virtual environments. Virtualization component 116 may host multiple virtual user operating environments 118 on the stack of CI components 110, 112, and 114. Virtual user operating environments 118 may each include a virtualized operating system (OS), and one or more applications (APs) executing in the virtualized OS. Components 110, 112, and 114 provide respective data storage, network, and compute resources required by each OS and the respective one or more APs. From a mechanical perspective, each of components 110-114 is typically housed in one or more rack-and-stack chassis. Each component chassis includes multiple input/output (I/O) signal ports, typically mounted on a back panel of the chassis, that communicate with, i.e., transmit signals to and/or receive signals from, I/O ports of the same component and/or I/O ports of other components over electrical cables connected between the communicating I/O ports.

At a high-level, CI Controller 108 serves as a unified, automated, resource configured to manage CI 106. CI Controller 108 includes one or more Graphical User Interfaces (GUIs) through which a user may issue commands and provide data to the CI Controller to selectively cause the controller to perform operations with respect to CI 106, such as to provision, configure, assess/validate, and monitor the CI. CI Controller 108 manages CI 106 over a bi-directional communication interface 122, including component interfaces 122a, 122b, 122c, and 122d each to communicate directly with a respective one of storage, network, compute, and virtualization components 110, 112, 114, and 116. Component interfaces 122a-122d may support communications in accordance with any number of different protocols, including, for example, a network protocol such as the HyperText Transfer Protocol (HTTP), Telnet, or Simple Network Management Protocol (SNMP). To the extent that components 110-116 of CI 106 support different interface protocols, such as a Rich Text or Extensible Markup Language (XML), component interfaces 122a-122d of CI Controller 108 correspondingly support the different protocols, and the CI Controller may be configured to communicate with components 110-116 using different protocols to maintain interface compatibility with the components as necessary.

As mentioned above, a specific design of CI 106 may be in accordance with a vendor blueprint. Because the blueprint complies with vendor specifications, the blueprint is said to represent or define a “validated” design or model (i.e., data model) of a CI. In one form, the blueprint is a human-readable text- and graphics-based document that defines to a user many manual step-by-step procedures, a cable specification, and related information required to configure and deploy each of the CI components of an actual, operating CI (e.g., CI 106) in accordance with the specific design. After CI 106 is configured and operating, CI components 110-116 may experience technical problems. CI controller 108 may be used to help troubleshoot and solve the technical problem, as is described below.

The techniques presented herein perform model-based (i.e., data model-based) CI component configuration capturing and replaying that assists with troubleshooting technical problems with CI components 110-116. The “capturing” refers to capturing or collecting a snap-shot of the CI component configurations at a given time, e.g., when CI 106 is experiencing the technical problems. The “replaying” refers to replaying or displaying the captured snap-shot of the CI component configurations to a user. Advantageously, the capturing may be performed onsite were CI 106 is located, while the replaying may be performed either onsite or, alternatively, at an offsite or remote location where CI 106 is not located. The replaying can be thought of as emulating the actual, operating CI configuration, including any technical problems with the operating CI.

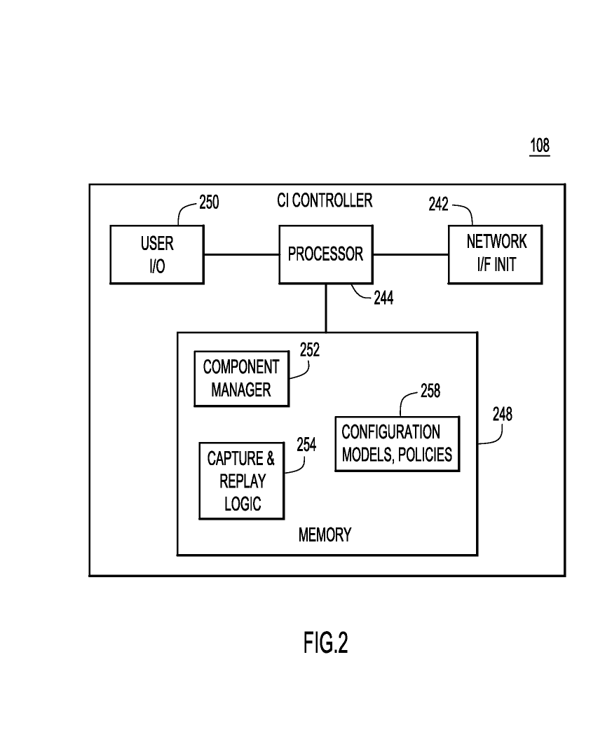

With reference to FIG. 2, there is shown an example block diagram of CI Controller 108 configured to perform operations described herein. There are numerous possible configurations for CI Controller 108 and FIG. 2 is meant to be an example. CI Controller 108 includes a network interface unit 242, a processor 244, memory 248, and a user Input/Output module 250 used in association with the one or more GUIs to enable the user to interface with the CI Controller. The network interface (I/F) unit 242 is, for example, an Ethernet card device that allows the CI Controller 108 to communicate over a network, e.g., a wired (Ethernet) network. Network I/F 242 may also include wireless connection capability. Interface 122 (from FIG. 1) may be implemented through network I/F unit 242. The processor 244 is a microcontroller or microprocessor, for example, configured to execute software instructions stored in the memory 248.

The memory 248 may comprise read only memory (ROM), random access memory (RAM), magnetic disk storage media devices, optical storage media devices, flash memory devices, electrical, optical, or other physical/tangible (e.g., non-transitory) memory storage devices. Thus, in general, the memory 248 may comprise one or more computer readable storage media (e.g., a memory device) encoded with software comprising computer executable instructions and when the software is executed (by the processor 244) it is operable to perform the operations described herein. For example, the memory 248 stores or is encoded with instructions for Component Manager Logic 252 to perform generalized management operations on CI 106 and Capture and Replay logic 254 to capture and replay CI component configurations. In addition, the memory 248 includes a memory portion 258 to store configuration models and policies or rules used by logic 254. The memory GUI logic may be divided among logic units 252 and 254 as necessary to support display features/elements of the respective logic operations.

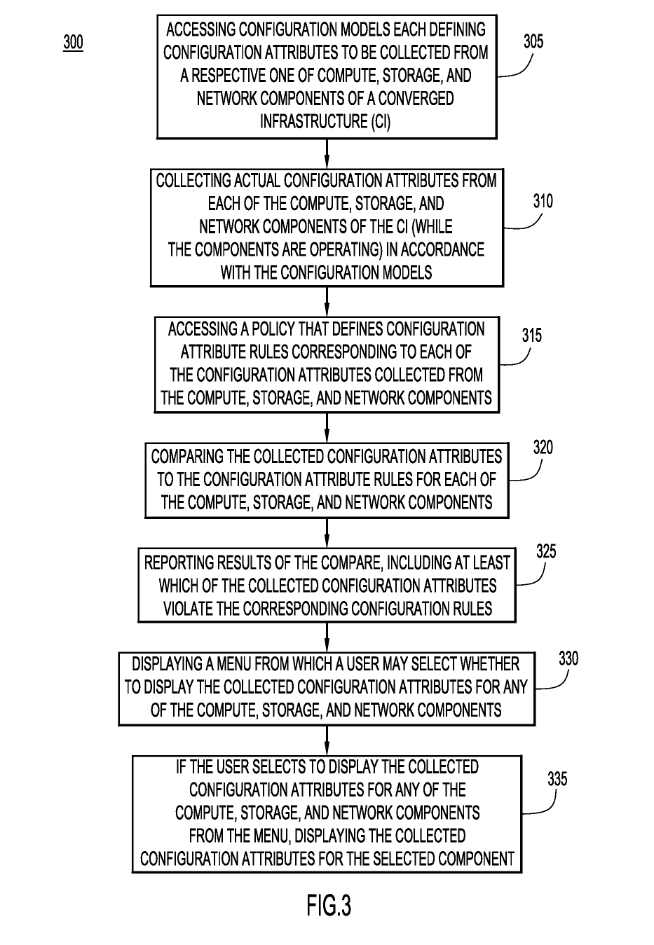

With reference to FIG. 3, there is a flowchart of an example generalized method 300 of model-based capturing and replaying of component configurations in support of both onsite and offsite CI troubleshooting embodiments. The operations of method 300 are performed by Capture and Reply logic 254.

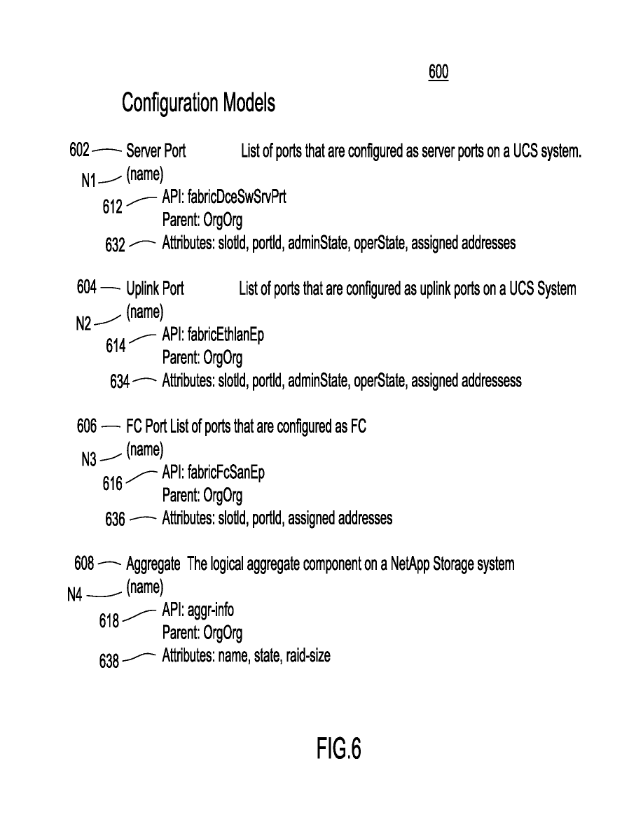

Method 300 assumes an a priori operation (not shown in FIG. 3) in which configuration models for each of CI components 110-114 are generated. A configuration model may also be referred to as a “configuration object model.” Each of the configuration models defines configuration attributes or parameters to be collected from a respective one of compute, storage, network, and virtualization components of CI 106. Each configuration model also includes one or more component (machine) readable commands to solicit actual configuration attributes from the respective component. The component readable commands are typically component vendor defined commands available from component specifications published by or available from the vendor. The configuration models may be formatted in accordance with an XML schema, although other structured data formats are possible. Example configuration models are described below in connection with FIG. 6. The configuration models are provided as inputs to method 300.

At operation 305, the configuration models described above are accessed.

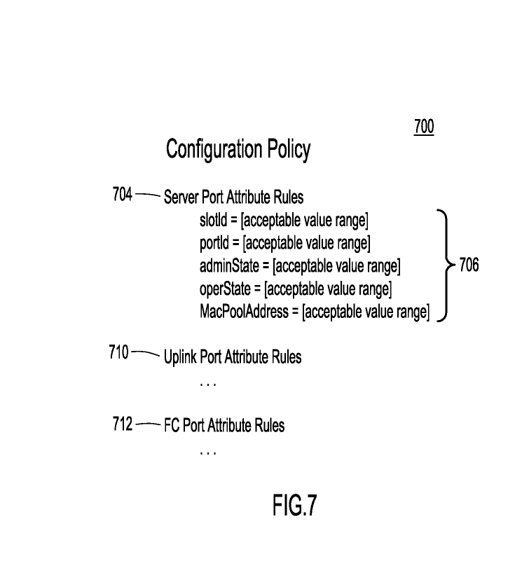

Next operation 310 includes capturing (i.e., collecting) actual configuration attributes from each of the compute, storage, and network components of CI 106 (while the components are operating) in accordance with the configuration models. The collecting in operation 310 includes the further operations of (i) providing the one or more component (machine) readable commands of each configuration model to the respective component (e.g., any of components 110-114 of CI 106), and (ii) receiving the actual configuration attributes solicited from the component in response to the provided command. Once the actual configuration attributes have been collected, they may be compiled in a structured manner into a configuration file, for convenient access by subsequent operations. An example of collected configuration attributes is described below in connection with FIG. 8. The collected configuration attributes represents a virtual CI stack of components.

Method 300 also assumes an a priori operation (not shown in FIG. 3) in which a configuration policy is generated. The configuration policy defines configuration attribute rules corresponding to each of the configuration attributes collected from the compute, storage, and network components of CI 106 in operation 310. An example configuration policy is described below in connection with FIG. 7.

At operation 315, the configuration policy is accessed.

Next operation 320 includes comparing the collected configuration attributes (from 310) to the configuration attribute rules of the configuration policy for each of the compute, storage, and network components of CI 106.

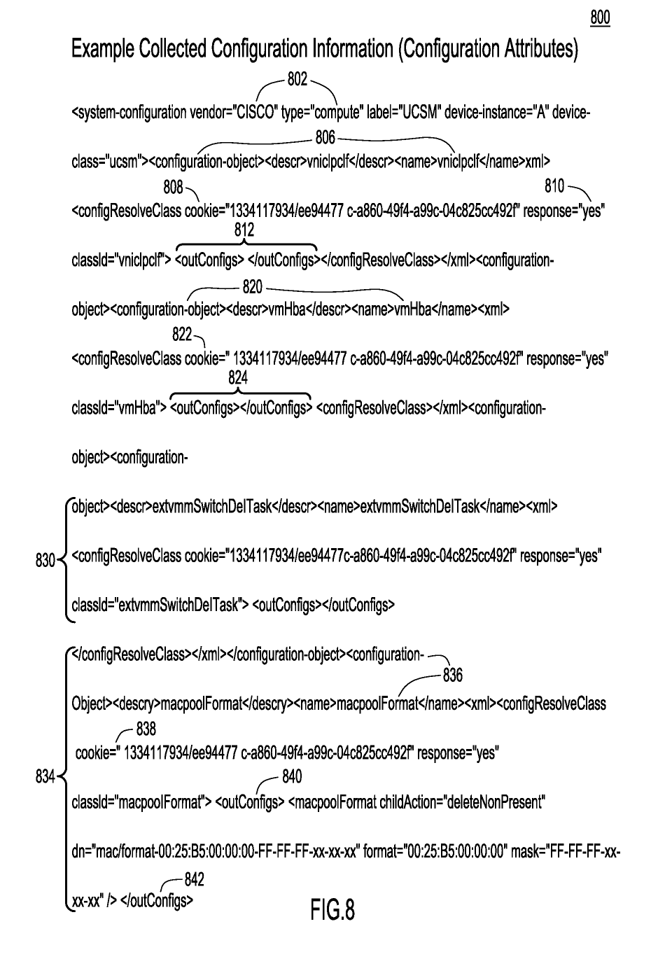

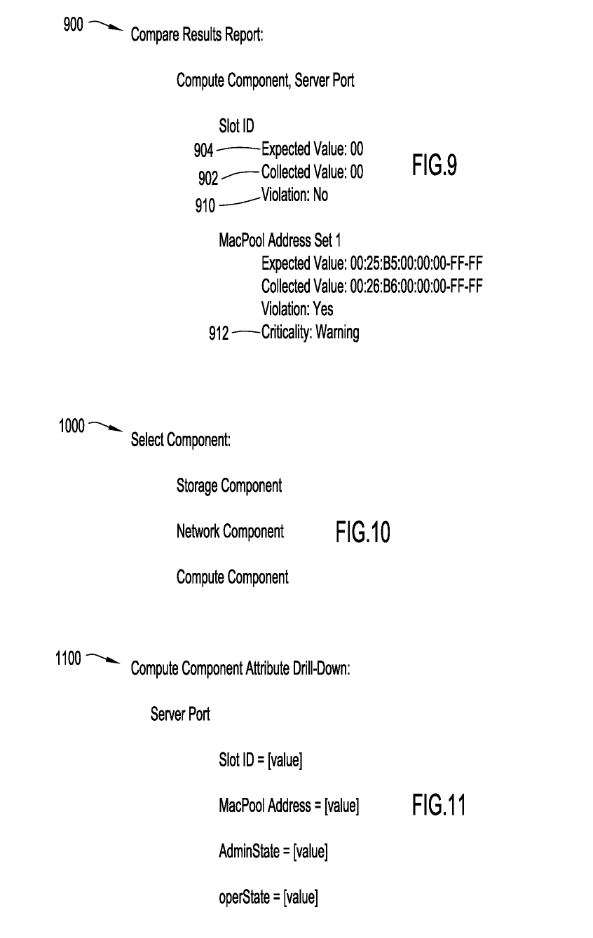

Next operation 325 includes reporting results of the comparing in operation 320. This includes reporting which of the collected configuration attributes violate the corresponding configuration attribute rules, if any, and which of the collected attributes do not violate the corresponding configuration attribute rules, as indicated in comparing operation 320. In addition, a criticality level of each violation (such as, e.g., a “warning” message or a “needs immediate attention” message) may also be reported, as will be described further below in connection with FIG. 9.

Next, operations 330 and 335 collectively represent “replaying” or emulating the collected configuration information, as is now described.

Operation 330 includes displaying a menu from which a user may select whether to display the collected (actual) configuration attributes for any of the compute, storage, and network components of CI 106. If the user selects to display the collected configuration attributes for any of the compute, storage, and network components of CI 106 from the menu, then flow proceeds to operation 335.

Operation 335 includes displaying the collected configuration attributes for the selected component. To do this, operation 335 may access the selected collected configuration attributes from the configuration file compiled in connection with operation 310, as described above. Example replay menus are described below in connection with FIGS. 10 and 11.

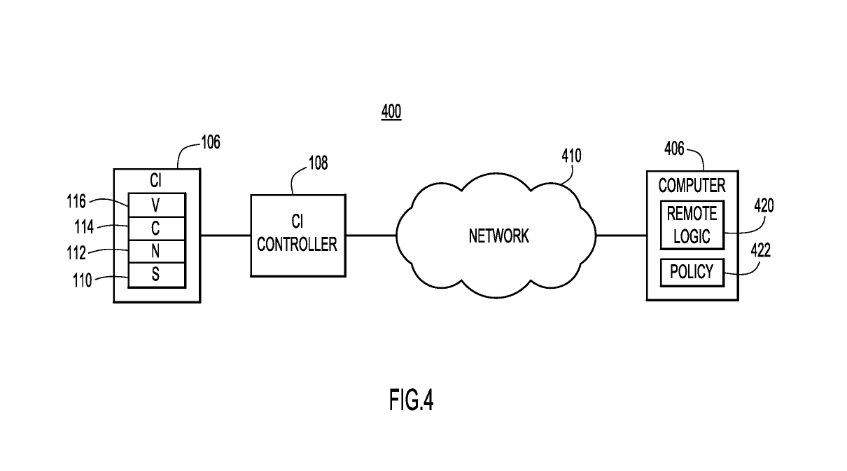

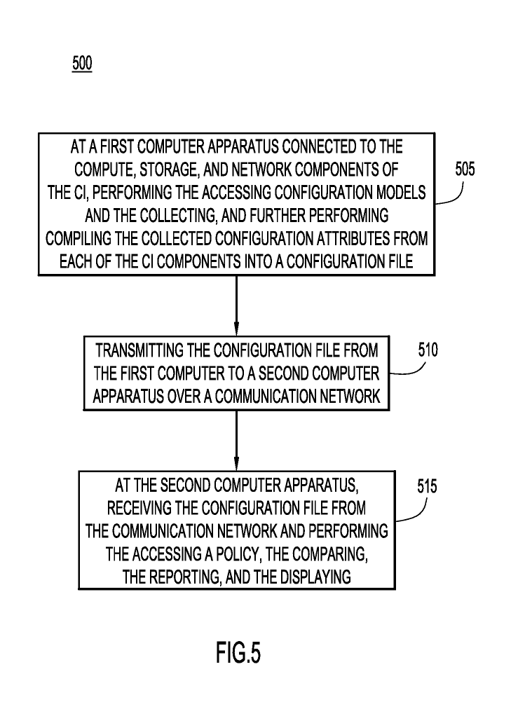

As mentioned above, method 300 supports both onsite and offsite troubleshooting embodiments. Turning to FIG. 4, an offsite troubleshooting environment 400 is depicted. Offsite troubleshooting environment 400 includes CI 106 operating under control of CI controller 108 in an onsite location. That is, CI 106 and CI controller 108 are co-located at the onsite location. Environment 400 includes a second computer apparatus 406, which may be a second instance of CI controller 108, located at an offsite or remote location that is geographically separated from the onsite location. Offsite computer apparatus 406 may be operated by a CI component SME on behalf of a vendor of any component of CI 106. CI controller 108 communicates with offsite computer apparatus 406 over a communication network 410, such as a wide area network (WAN), e.g., the Internet. Computer apparatus 406 may include user I/O, a processor, a network interface, and memory similar to CI controller 108. The memory of computer apparatus 406 may store (i) Remote logic 420 configured to perform at least accessing a policy, comparing, reporting, and replay operations 315-335 described above in connection with FIG. 3, and (ii) a rules policy 422 as also described above. Operations associated with offsite troubleshooting are now described with reference to FIG. 5, which is a flowchart of operations for an example method 500 associated with the offsite troubleshooting embodiment. FIG. 5 is described also with continued reference to FIGS. 3 and 4.

At 505, onsite CI controller 108 (the “first computer apparatus”), connected to the compute (C), storage (S), network (N), and virtualization (V) components of CI 106, performs operation 305 to access configuration models and operation 310 to collect actual configuration attributes from CI 106. Then, CI controller 108 compiles the collected actual configuration attributes from each of the CI components into a configuration file.

At 510, onsite CI controller 108 transmits the configuration file to offsite computer apparatus 406 over communication network 410. For example, the configuration file may be attached to an email message addressed and sent to computer apparatus 406.

At 515, offsite computer apparatus 406 (“the second computer apparatus”) receives the configuration file from communication network 410, and performs the following operations described above in connection with the received configuration file: operation 320 to compare the collected configuration attributes conveyed in the received file to the policy; operation 325 to report the results of the compare; and operations 330 and 335 to selectively display the collected configuration attributes from the received configuration file and, therefore, replay the configuration collected from the onsite location at the offsite location.

Turning now to FIG. 6, example configuration models 600 are depicted. Configuration models 600 include: a “Server Port” configuration model 602 for server ports of compute component 114 (compute component 114 is also referred to in FIG. 6 as a Unified Computing System (“UCS”)); an “Uplink Port” configuration model 604 for uplink ports of the UCS; a fiber channel (FC) port “FC Port” configuration model 606 for network component 112; and an “Aggregate” configuration data model 608 for storage component 110 (also referred to in FIG. 6 as a “NetApp Storage System”). Configuration models 602-608 may each be formatted according to an XML schema or data format/structure. Each of individual configuration models 602-608 of configuration model 600 is also referred to herein as a “configuration object model,” or more simply as a “configuration object.” Therefore, a given configuration model, such as configuration model 600, may be said to include many individual “configuration objects.”

Configuration models 602, 604, 606, and 608 may optionally include respective names (“name”) N1, N2, N3, and N4 to uniquely identify the corresponding models or objects.

Configuration models 602, 604, 606, and 608 include respective component/machine readable commands 612, 614, 616, and 618 also referred to as application programming interface (API) commands. For example, command 612 is represented as “API: “fabricDceSwSrvPrt.” Each API command may be considered as a “get attribute” command to solicit configuration attributes from a targeted component that, when provided to the targeted component, causes that component to respond with its actual configuration attributes.

Configuration models 602-608 also include respective lists of configuration attributes 632-638 to be collected from respective ones of CI components 110-114 responsive to API commands 612-618. For example, configuration attribute list 632 for Server Port lists the configuration attributes: slotId, portId, adminState, operState, assigned addresses. (e.g., MacPool addresses)

Each of configuration models 602-608 is also associated with a high level organizational name “OrgOrg,” as depicted in FIG. 6.

Turning now to FIG. 7, there is depicted an example policy 700 corresponding to configuration models 600 in FIG. 6. Policy 700 includes Server Port Attribute Rules 704, corresponding to Server Port configuration model 602, that define acceptable values 706 for configuration attributes 632 of model 602 (i.e., for attributes slotId, portId, adminState, operState, assigned addresses (e.g., MacPoolAddress)).

Policy 700 similarly includes Uplink Port Attribute Rules 710, FC Port Attribute Rules 712, and so on, corresponding to the configuration attributes associated with Uplink Port configuration model 604, FC Port configuration model 606, and so on.

Turning now to FIG. 8, there is depicted an example “data-dump” of actual configuration attributes 800 collected from CI 106, and formatted in accordance with an XML schema, at operation 310 of method 300. Actual configuration attributes 800 are also referred to herein simply as the “data” for convenience. The schema (e.g., XML data format/structure) of the data represented in FIG. 8 reflects the schema of the one or more configuration models or objects used to collect the attributes 800.

At 802 the data indicates that the vendor of the component from which the data was collected is “CISCO” and that the data was collected from a “compute” component (which is the targeted component). 806 indicates the data collected is for, or corresponds to, a configuration object (i.e., configuration model) named “vniclplf.” 808 indicates a Cookie was returned from the targeted component. 810 indicates the targeted component did respond with some data (e.g., the Cookie).

In the data, actual (returned) collected attribute information is inserted between consecutive “<outConfigs>” statements. Accordingly, at 812, the null information between consecutive “<outConfigs>” statements indicates that no actual configuration attributes were returned for configuration model or object “vniclpclf.”

At 820, a next configuration model or object “vmHba” is indicated. VmHba returns a Cookie at 822, but no actual configuration attributes at 824.

Similarly, at 830, a next configuration model named “extvmmSwitchDelTask” returns a Cooke, but no actual configuration attributes.

At 834, a next configuration model named “macpoolFormat” (836) returns a Cookie at 838 and actual configuration attributes between consecutive “<outConfigs>” statements at 840 and 842. The actual configuration attributes include, inter alia, portions of block mac addresses designated, e.g., “00:25:B5:00:00:00-FF-FF-FF-xx-xx-xx.”

As described above in connection with operations 310 of FIG. 3 and 505 of FIG. 5, the actual configuration attributes collected from targeted CI components 110-114 may be compiled into a structured file for convenient access in later operations. In an example, collected configuration attributes 800 in FIG. 8 may be compiled into the configuration file. In other words, the data of FIG. 8 along with other similar data-dumps from other targeted components may be compiled into a configuration file. The data of FIG. 8 may be compiled into the configuration file in the same XML format or schema indicated in FIG. 8. As such, the data of FIG. 8 also represents an example of a configuration file that may be transmitted offsite, i.e., to a remote site.

Returning again to method 300 in FIG. 3, reporting operation 325 reports results of compare operation 320. In one embodiment, reporting operation 325 generates and displays the compare results to the user through a GUI. FIG. 9 is an illustration of an example Compare Results Report 900 generated and displayed in operation 325. Report 900 indicates compare results corresponding to configuration model 602 of FIG. 6 for the “Server Port” of compute component 114. Report 900 lists configuration attributes “SlotID” and “MacPool Address Set 1” for which configuration attribute values were collected, and indicated at “Collected Value” 902. For each configuration attribute (e.g., Server Port Slot ID), the report lists the “Expected Value” (e.g., at 904) of the attribute specified in the corresponding configuration rule (e.g., for Server Port Slot ID, this is the expected value listed in configuration policy rule 704, 706 of configuration policy 700 of FIG. 7). Then, for each configuration attribute, the report also lists whether the corresponding rule was violated (e.g., “Violation: Yes”) or not violated (e.g., “Violation: No” at 910) based on a compare in operation 320 of method 300 between the configuration attribute collected and expected values. For each configuration attribute, if the attribute is in violation, the report also lists a criticality level associated with the violation, e.g., low criticality=“warning” at 912 and high criticality=“needs immediate attention.”

As was also described above in connection with method 300, operations 330 and 335 collectively implement a replay operation in which collected configuration attributes may be selectively displayed to a user. FIGS. 10 and 11 are illustrations of example replay display menus 1000 and 1100 generated in operations 330 and 335, respectively. Menu 1000 entitled “Select Component” permits a user to select a component, e.g., storage, network, or compute component, for which collected configuration attributes are to be displayed. Assuming the user selects the compute component from menu 1000 in operation 330, then operation 335 generates and displays menu 1100 entitled “Compute Component Attribute Drill-Down” to display the collected configuration attributes for the compute component. In the example of FIG. 11, configuration attributes collected from “Server Port” are displayed in accordance with configuration model 600, 602, 632.

Techniques provided herein perform model-based (i.e., data model-based), automated, CI component configuration capturing and replaying that assists with troubleshooting technical problems with CI components in both onsite and offsite locations. The techniques automatically capture or collect an entire CI configuration onsite and then selectively replay the captured configuration remotely in order to emulate the onsite CI at the offsite location. Such emulation of the configuration, including its vulnerabilities, helps an SME at the remote site to identify and troubleshoot problems with the CI efficiently and thoroughly.

In summary, in one form, a method is provided, comprising: accessing configuration models each defining configuration attributes to be collected from a respective one of compute, storage, and network components of a converged infrastructure; collecting actual configuration attributes from each of the compute, storage, and network components of the converged infrastructure in accordance with the configuration models; accessing a policy that defines configuration attribute rules corresponding to each of the configuration attributes collected from the compute, storage, and network components; comparing the collected configuration attributes to the configuration attribute rules for each of the compute, storage, and network components; and reporting results of the comparing, including which of the collected configuration attributes violate the corresponding configuration rules, if any.

In another form, an apparatus is provided, comprising: a network interface unit configured to send and receive communications over a network; and a processor coupled to the network interface unit, and configured to: access configuration models each defining configuration attributes to be collected from a respective one of compute, storage, and network components of a converged infrastructure; collect actual configuration attributes from each of the compute, storage, and network components of the converged infrastructure in accordance with the configuration models; access a policy that defines configuration attribute rules corresponding to each of the configuration attributes collected from the compute, storage, and network components; compare the collected configuration attributes to the configuration attribute rules for each of the compute, storage, and network components; and report results of the compare, including which of the collected configuration attributes violate the corresponding configuration rules.

In still another form, a processor readable medium is provided for storing instructions that, when executed by a processor, cause the processor to: access configuration models each defining configuration attributes to be collected from a respective one of compute, storage, and network components of a converged infrastructure; collect actual configuration attributes from each of the compute, storage, and network components of the converged infrastructure in accordance with the configuration models; access a policy that defines configuration attribute rules corresponding to each of the configuration attributes collected from the compute, storage, and network components; compare the collected configuration attributes to the configuration attribute rules for each of the compute, storage, and network components; and report results of the compare, including which of the collected configuration attributes violate the corresponding configuration rules.

Although the apparatus, system, and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following claims.

What is claimed is:

1. A method comprising:
accessing configuration models each defining configuration attributes to be collected from a respective one of compute, storage, and network components of a converged infrastructure;
collecting actual configuration attributes from each of the compute, storage, and network components of the converged infrastructure in accordance with the configuration models;
accessing a policy that defines configuration attribute rules corresponding to each of the configuration attributes collected from the compute, storage, and network components;
comparing the collected configuration attributes to the configuration attribute rules for each of the compute, storage, and network components; and
reporting results of the comparing, including which of the collected configuration attributes violate the corresponding configuration rules, if any.

2. The method of claim 1, further comprising:
displaying a menu from which a user may select whether to display the collected configuration attributes for any of the compute, storage, and network components; and
if the user selects to display the collected configuration attributes for any of the compute, storage, and network components from the menu, displaying the collected configuration attributes for the selected component.

3. The method of claim 1, wherein:
each configuration model includes one or more component readable commands to solicit the actual configuration attributes from the respective component; and
the collecting includes:
providing the one or more component readable commands of each configuration model to the respective component; and
receiving the actual configuration attributes solicited from the component by the provided command.

4. The method of claim 3, wherein:
each configuration model is structured according to a first Extensible Mark-up Language (XML) schema including a configuration model name, a list of configuration attributes to be collected, and the one or more component readable commands to solicit the actual configuration attributes listed in the corresponding list of configuration attributes to be collected; and
the receiving includes receiving the actual configuration attributes and formatting the received actual configuration attributes according to a second XML schema based on the corresponding first XML schema, including a specific name associated with the component from which the configuration attributes were solicited, an indication of whether actual configuration attributes were returned from the solicited component, and a list of the actual configuration attributes that were returned.

5. The method of claim 4, further comprising:
compiling the formatted actual configuration attributes collected from each of the components into a configuration file; and
transmitting the configuration file over a communication network.

6. The method of claim 1, further comprising:
compiling the actual configuration attributes collected from each of the components into a configuration file; and
transmitting the configuration file over a communication network.

7. The method of claim 1, wherein:
each configuration attribute rule of the policy defines an acceptable configuration attribute value for a respective configuration attribute and a criticality level associated with a violation of the rule;
the comparing includes comparing the collected configuration attributes corresponding to each of the converged infrastructure components against the corresponding acceptable configuration attribute values; and
the reporting includes reporting any rule violation indicated by the compare results and the criticality level associated with the rule violation.

8. The method of claim 1, further comprising:
at a first computer apparatus connected to the compute, storage, and network components of the converged infrastructure, performing the accessing configuration models and the collecting, and further performing compiling the collected configuration attributes from each of the converged infrastructure components into a configuration file;
transmitting the configuration file from the first computer apparatus to a second computer apparatus over a communication network; and
at the second computer apparatus, receiving the configuration file from the communication network and performing the accessing a policy, the comparing, and the reporting.

9. An apparatus comprising:
a network interface unit configured to send and receive communications over a network; and
a processor coupled to the network interface unit, and configured to:
access configuration models each defining configuration attributes to be collected from a respective one of compute, storage, and network components of a converged infrastructure;
collect actual configuration attributes from each of the compute, storage, and network components of the converged infrastructure in accordance with the configuration models;
access a policy that defines configuration attribute rules corresponding to each of the configuration attributes collected from the compute, storage, and network components;
compare the collected configuration attributes to the configuration attribute rules for each of the compute, storage, and network components; and
report results of the compare, including which of the collected configuration attributes violate the corresponding configuration rules.

10. The apparatus of claim 9, wherein the processor is further configured to:
display a menu from which a user may select whether to display the collected configuration attributes for any of the compute, storage, and network components; and
if the user selects to display the collected configuration attributes for any of the compute, storage, and network components from the menu, display the collected configuration attributes for the selected component.

11. The apparatus of claim 9, wherein:
each configuration model includes one or more component readable commands to solicit the actual configuration attributes from the respective component; and
the processor is configured to collect by:
providing the one or more component readable commands of each configuration model to the respective component; and
receiving the actual configuration attributes solicited from the component by the provided command.

12. The apparatus of claim 11, wherein:
each configuration model is structured according to a first Extensible Mark-up Language (XML) schema including a configuration model name, a list of configuration attributes to be collected, and the one or more component readable commands to solicit the actual configuration attributes listed in the corresponding list of configuration attributes to be collected; and
the processor is configured to perform the receiving by receiving the actual configuration attributes and formatting the received actual configuration attributes according to a second XML schema based on the corresponding first XML schema, including a specific name associated with the component from which the configuration attributes were solicited, an indication of whether actual configuration attributes were returned from the solicited component, and a list of the actual configuration attributes that were returned.

13. The apparatus of claim 12, the processor is further configure to:
compile the formatted actual configuration attributes collected from each of the components into a configuration file; and
transmit the configuration file to a second computer apparatus over a communication network.

14. The apparatus of claim 9, wherein:
each configuration attribute rule of the policy defines an acceptable configuration attribute value for a respective configuration attribute and a criticality level associated with a violation of the rule;
the processor is configured to compare by comparing the collected configuration attributes corresponding to each of the converged infrastructure components against the corresponding acceptable configuration attribute values; and
the processor is configured to report by reporting any rule violation indicated by the compare results and the criticality level associated with the rule violation.

15. A non-transitory processor readable medium storing instructions that, when executed by a processor, cause the processor to:
access configuration models each defining configuration attributes to be collected from a respective one of compute, storage, and network components of a converged infrastructure;
collect actual configuration attributes from each of the compute, storage, and network components of the converged infrastructure in accordance with the configuration models;
access a policy that defines configuration attribute rules corresponding to each of the configuration attributes collected from the compute, storage, and network components;
compare the collected configuration attributes to the configuration attribute rules for each of the compute, storage, and network components; and
report results of the compare, including which of the collected configuration attributes violate the corresponding configuration rules.

16. The processor readable medium of claim 15, further comprising instructions to cause the processor to:
display a menu from which a user may select whether to display the collected configuration attributes for any of the compute, storage, and network components; and
if the user selects to display the collected configuration attributes for any of the compute, storage, and network components from the menu, display the collected configuration attributes for the selected component.

17. The processor readable medium of claim 15, wherein:
each configuration model includes one or more component readable commands to solicit the actual configuration attributes from the respective component; and
the instruction to cause the processor to collect include instructions to cause the processor to:
provide the one or more component readable commands of each configuration model to the respective component; and
receive the actual configuration attributes solicited from the component by the provided command.

18. The processor readable medium of claim 17, wherein:
each configuration model is structured according to a first Extensible Mark-up Language (XML) schema including a configuration model name, a list of configuration attributes to be collected, and the one or more component readable commands to solicit the actual configuration attributes listed in the corresponding list of configuration attributes to be collected; and
the instructions to cause the processor to receive include instructions to cause the processor to receive the actual configuration attributes and format the received actual configuration attributes according to a second XML schema based on the corresponding first XML schema, including a specific name associated with the component from which the configuration attributes were solicited, an indication of whether actual configuration attributes were returned from the solicited component, and a list of the actual configuration attributes that were returned.

19. The processor readable medium of claim 18, further comprising instructions to cause the processor to:
compile the formatted actual configuration attributes collected from each of the components into a configuration file; and
transmit the configuration file over a communication network.

20. The processor readable medium of claim 15, wherein:
each configuration attribute rule of the policy defines an acceptable configuration attribute value for a respective configuration attribute and a criticality level associated with a violation of the rule;
the instructions to cause the processor to compare include instructions to cause the processor to compare the collected configuration attributes corresponding to each of the converged infrastructure components against the corresponding acceptable configuration attribute values; and
the instructions to cause the processor to report include instructions to cause the processor to report any rule violation indicated by the compare results and the criticality level associated with the rule violation.
